(19) United States
(12) Patent Application Publication
(10) Pub. No.: US 2026/0269525 A1
(43) Pub. Date: Sep. 10, 2026

(54) ELECTRICAL CONNECTION AND COMPONENTS OF AN ELECTRICAL CONNECTION

(71) Applicant: TE Connectivity Solutions GmbH, Schaffhausen (CH)

(72) Inventors: Kevin SCHEER, Schaffhausen (CH); Harald ULRICH, Schaffhausen (CH); Stefan MASAK, Schaffhausen (CH)

(21) Appl. No.: 19/556,108

(22) Filed: Mar. 4, 2026

(30) Foreign Application Priority Data
Mar. 5, 2025 (DE) 102025108408.4

(51) Int. Cl. H01R 13/629

(52) U.S. Cl. CPC H01R 13/62944; H01R 13/62955

(57) ABSTRACT

An electrical plug connector for establishing an electrical and mechanical connection with a corresponding pin interface includes a plug body configured to receive at least one electrical conductor; a lever mounted on the plug body so as to be rotatable about a virtual axis of rotation between a locked position and a released position; at least one first connecting structure, which is arranged on the lever at a first distance from the axis of rotation which is configured to cooperate with at least one corresponding second connecting structure arranged on the pin interface to hold the plug connector on the pin interface; at least one actuator component arranged on the lever which is configured to deflect at least one elastic retaining component arranged at the pin interface.

### CROSS REFERENCE TO RELATED APPLICATIONS

This application claims the benefit of DE Application No. 102025108408.4, filed 5 Mar. 2025, the subject matter of which is herein incorporated by reference in its entirety.

### BACKGROUND OF THE INVENTION

The subject matter herein relates to an electrical plug connector and a corresponding pin interface, also known as a header, preferably for use in the automotive sector, in particular for high-voltage applications.

In electrical engineering, there are a large number of known electrical connections that serve to transmit electrical signals or voltages and, if necessary, electrical currents with the widest possible range of voltages, data rates or frequencies and electrical currents. In the automotive sector in particular, electrical interfaces for such connections must ensure the permanent, flawless transmission of electronic signals or data and, where applicable, electrical power under significant temperature stress, a high number of mating cycles and vibration stress. Due to the wide range of applications for connections, a large number of such interfaces are known.

High-voltage interfaces (HV interfaces) are used in the automotive sector, for example, to transmit electrical power between the drive battery of an electric vehicle and the motor. In this context, connections that can be made and disconnected without tools are preferred in order to simplify, for example, battery installation or necessary maintenance work, during which the battery must be electrically disconnected from the vehicle. The mechanical quality of the connection plays a particularly important role here, as degradation of the connection can lead directly to a loss of performance during driving. In order to ensure mechanical quality, prior-art plug connections often feature mechanical locks that eliminate play and relative movements in the connections and are intended to prevent the connection from being accidentally disconnected. The inventors have found that the mechanical locks of currently available plug connections often do not guarantee complete elimination of play and wear in the connection in the long term.

### BRIEF DESCRIPTION OF THE INVENTION

One object of the invention is to provide an improved electrical plug connector and an improved electrical pin interface, particularly in the high-voltage range and particularly for the automotive sector. The aim here is to improve the durability and mechanical resistance of the connection. In addition, the pin interface should be inexpensive and easy to assemble. A further object of the invention is to provide an alternative electrical plug connector and an alternative electrical pin interface.

An object of the invention is achieved by an electrical plug connector, in particular for the automotive sector, according to the claims; and by an electrical pin interface, in particular for the automotive sector, according to the claims. Advantageous developments, additional features and/or advantages of the invention can be found in the dependent claims and the following description.

According to a first aspect, the following is disclosed: An electrical plug connector, in particular for the automotive sector, for establishing an electrical and mechanical connection with a corresponding pin interface, comprising: a plug body configured to receive at least one electrical conductor; a lever attached to the plug body so as to be rotatable about a virtual axis of rotation between a locked position and a released position; at least one first connecting structure, which is arranged on the lever at a first distance from the axis of rotation and which is configured: in the locked position of the lever, to cooperate with at least one corresponding second connecting structure arranged on the pin interface in order to hold the plug connector on the pin interface when the plug connector and the pin interface are engaged with each other; and in the released position of the lever, to allow displacement of the plug connector relative to the pin interface; at a second distance from the axis of rotation on the lever, at least one actuator component which is configured: in the locked position of the lever, to deflect at least one elastic retaining component arranged on the pin interface in such a way that it interacts with a corresponding retaining structure arranged on the plug body to hold the plug connector at the pin interface when the plug connector and the pin interface are engaged with each other; and in the released position of the lever, to allow displacement of the plug connector relative to the pin interface.

The design of the plug connector defined above ensures that the mechanical position lock can not only absorb forces along the mating direction of the plug connector, but also tilt moments acting on the connection, which in prior-art solutions cause the plug connector to lift off the pin interface, also known as the “header”, in certain regions. This partial lifting is prevented or at least largely eliminated with the solution presented. Wear and degradation of the electrical connection are thus minimized.

There are also other advantages, for example with regard to the simple and repeatedly reliable manufacturability of the connection, as well as its easy detachability, which is advantageous, for example, in conjunction with maintenance work on electrical components that require the disconnection of an electrical connection.

The lever may comprise at least a first lever arm with a first end and a second end, and the first lever arm may be connected at the first end to the plug body so as to be rotatable about the virtual axis of rotation, wherein the actuator component is arranged on the lever arm in such a way that, when the lever is moved from the released position to the locked position, it describes a path movement which has a movement component along a mating direction of the plug connector and the pin interface.

The actuator component may have a substantially wedge-shaped pressure region with a pointed end and a broad end, wherein the pointed end is oriented such that, when the lever is moved from the released position to the locked position, the pointed end points substantially in the direction of movement.

The pressure region may have a surface inclined relative to the direction of movement, which connects the pointed end to the broad end and is configured to contact a free end of the retaining component when the lever is moved from the released position to the locked position and to deflect it perpendicular to the direction of movement of the lever in the direction of the plug body.

The actuator component may be formed integrally with the lever.

The lever arm may have a first latching element at the second end, which is configured to interact with a corresponding second latching element arranged on the plug body in order to hold the lever in the locked position on the plug body.

The first connecting structure may be arranged at the first end and the actuator component between the first end and the first latching element.

The first connecting structure may be arranged on a first side of the virtual axis of rotation with respect to a main direction of extent of the lever in the locked position of the lever, and the actuator component on a second side opposite the first side.

The first connecting structure may comprise at least one tooth of which the longitudinal axis is aligned in a radial direction with respect to the axis of rotation.

The at least one tooth may have a free end remote from the axis of rotation, which undergoes a movement during movement of the lever from the released position to the locked position, which movement has a movement component along a mating direction of the plug connector and the pin interface.

The lever may comprise a second lever arm aligned parallel to the first lever arm and formed substantially mirror-symmetrical to it, wherein the first lever arm and the second lever arm are connected at their respective second ends to a bracket oriented substantially perpendicular to the lever arms.

The electrical plug connector may comprise a first axle stub and a second axle stub, each aligned along the virtual axis of rotation and each formed as a mounting point for the first end of the first lever arm and the first end of the second lever arm.

According to a further aspect, the following is disclosed: An electrical pin interface, in particular for the automotive sector, for establishing an electrical connection with a corresponding plug connector as described above, comprising: a main body; a contact assembly with at least one electrical contact, held on the main body and at least partially surrounded by it; the main body having at least a second connecting structure which is configured: to cooperate with at least one corresponding first connecting structure arranged on the plug connector to hold the plug connector on the pin interface when the plug connector and the pin interface are engaged with each other; at least one elastic retaining component arranged on the lever at a third distance from the second connecting structure, which is configured: to be deflected by at least one actuator component arranged on the plug connector, in such a way that it interacts with a corresponding retaining structure arranged on a plug body of the plug connector to hold the plug connector at the pin interface when the plug connector and the pin interface are engaged with each other.

The advantages of the pin interface are analogous to the advantages of the electrical plug connector described above.

The at least one retaining component may comprise a spring arm, which extends along a mating direction of the pin interface and the plug connector and which comprises a free end that can be deflected perpendicular to the mating direction and a second end that is clamped to the pin interface in a spring-elastic manner.

The free end may have a hook-shaped deformation and the retaining structure may have a shoulder corresponding to the hook-shaped deformation.

The free end may have a substantially V-shaped bulge oriented substantially perpendicular to a main direction of extent of the spring arm, and the retaining structure may have a corresponding V-shaped recess.

The at least one retaining component may be formed in the main body.

The at least one retaining component may comprise a first retaining component and a second retaining component, which are connected to each other at their respective second ends by a connecting web, so that the first retaining component, the second retaining component and the connecting web form a substantially U-shaped spring clip.

The spring clip may be connected to the main body in the region of the connecting web, preferably by screws.

The spring clip may form a support in the region of the connecting web, extending substantially perpendicular to the mating direction, which defines an end position of the plug connector when the plug connector and the pin interface are engaged with each other.

The spring clip may be stamped from a single piece of sheet metal and formed by edges.

The second connecting structure may comprise at least one notch, which corresponds to the first connecting structure and which is aligned in its longitudinal direction substantially perpendicular to the mating direction.

The electrical pin interface may have at least one connection socket for attaching the pin interface to a surface, in particular to a vehicle battery housing.

According to a further aspect, the following is disclosed: An electrical connection, in particular for the automotive sector, comprising an electrical plug connector as described above and an electrical pin interface as described above. The advantages of the pin interface are analogous to the advantages of the electrical plug connector described above.

The invention is explained in more detail below with reference to the accompanying drawing and exemplary embodiments.

### BRIEF DESCRIPTION OF THE DRAWINGS

The figures in the drawing show:

FIGS. 1a and 1b illustrate perspective views of embodiments of an electrical plug connector and a corresponding pin interface;

FIG. 2 illustrates a perspective view of an embodiment of an electrical pin interface;

FIGS. 3a and 3b views of components of embodiments of an electrical plug connector and a corresponding pin interface;

FIGS. 4a and 4b views of components of embodiments of an electrical plug connector and a corresponding pin interface;

FIGS. 5a and 5b views of components of an embodiment of an electrical pin interface; and

FIGS. 6a and 6b are perspective views of embodiments of an electrical plug connector and a corresponding pin interface.

### DETAILED DESCRIPTION OF THE INVENTION

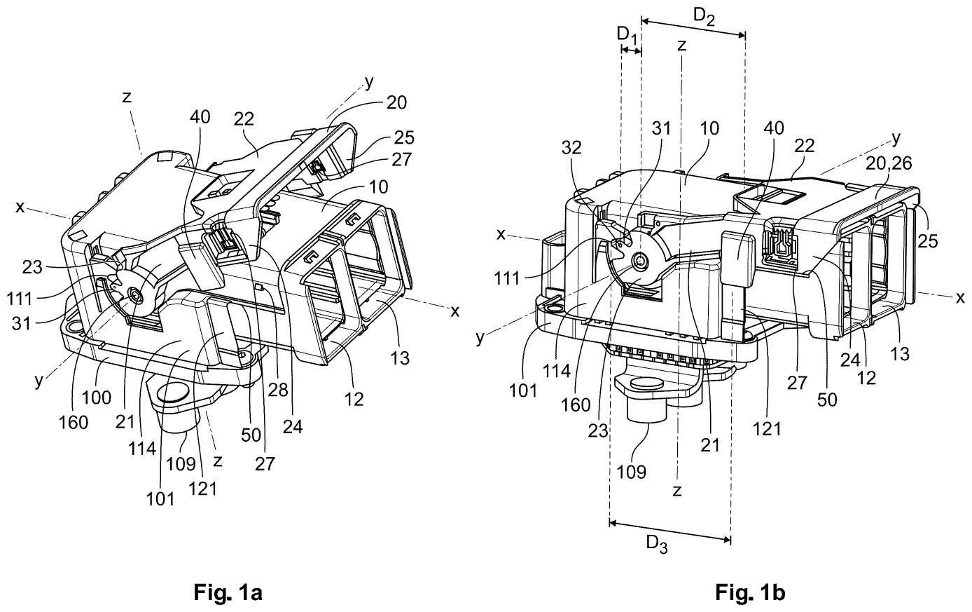

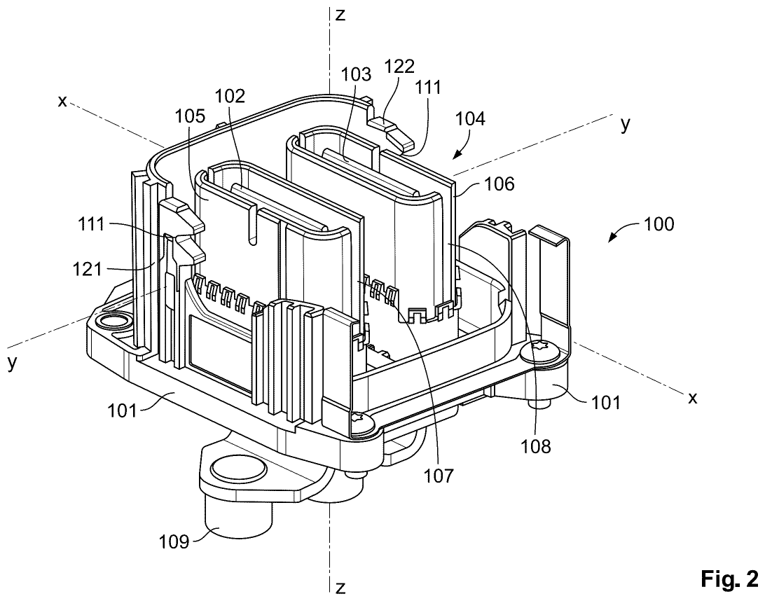

With reference to FIGS. 1 to 6, the structure and operation of an electrical connection, as well as an electrical plug connector and an electrical pin interface, are described schematically below. Corresponding reference signs are used for corresponding features.

FIG. 1 shows components of an electrical connection 1, which in the configuration shown in FIG. 1 is a high-voltage connection (HV connection). The electrical connection 1 comprises a plug connector 10 and a pin interface 100 of a type also known in the prior art as a “header”. The terms “pin interface” and “header” can be used synonymously for the purposes of the application. The plug connector 10 and the pin interface 100 can be connected and disconnected from each other along a mating direction z-z. The electrical connection 1 has a contact assembly 104 on the side of the pin interface 100, which comprises a first electrical contact 102 and a second electrical contact 103. In a manner not further illustrated, the first electrical contact 102 and the second electrical contact 103 can be connected in applications of the electrical connection 1 via contacting portals 109, for example, to opposite potentials of a battery, for example, a drive battery of an electric motor vehicle.

Both the first electrical contact 102 and the second electrical contact 103 are arranged on a main body 101 and are protected from mechanical influences and unintentional electrical contact by corresponding first 105 and second wall structures 106 that shield the respective contact 102, 103 perpendicular to the mating direction z-z. In order to allow intended contacting of the electrical contacts 102, 103 along the mating direction z-z by electrical mating-contacts extending perpendicular to the mating direction z-z, slot-like recesses 107, 108 are arranged in the wall structures 105, 106 perpendicular to the mating direction z-z.

The plug connector 10 comprises a plug body 11, which in the embodiment shown is configured to receive two electrical conductors (not shown). In the embodiment shown, the plug body 11 has a first opening 12 for receiving a first electrical conductor corresponding to the first electrical contact 102, and a second opening 13 for receiving a second electrical conductor corresponding to the second electrical contact 103.

The electrical conductors can be configured as rigid, sword-like mating contacts of which the main direction of extent runs perpendicular to the mating direction z-z. In FIG. 1, this main direction of extent runs parallel to the axis x-x. As already mentioned above, in such a configuration, the slot-like recesses 107, 108 allow the mating contacts to be inserted into the regions of the contact assembly 104 protected by the first 105 and second wall structures 106.

The mechanical positioning of the plug connector 10 at the pin interface 100 is achieved in the electrical connection 1 disclosed herein in a manner that minimizes relative movements between the two connection partners and the associated wear of the contacts 102, 103 and mating contacts, and ensures that a consistently high level of electrical power transmission is possible in the long term.

The basic principle can be described in simplified terms as follows: the mechanical position locking mechanism can not only absorb forces along the mating direction z-z, but also tilting moments acting on the connection 1, which in solutions known in the prior art cause the plug connector to lift off the pin interface in certain regions. Such tilting moments can arise, for example, when the electrical conductors terminating in the plug connector are lifted at a distance from the plug connector 10 in the direction of mating z-z, wherein tilting moments relevant to wear are already sufficient if this lifting is in the order of magnitude of vibrations occurring during the operation of a motor vehicle.

This lifting in regions is prevented or at least largely eliminated with the solution presented. Wear and degradation of the electrical connection are minimized. The solution described below offers further advantages, for example in terms of its simple and repeatedly reliable manufacturability and solubility, as can be seen from the following explanations.

A lever 20 that can rotate about a virtual axis of rotation y-y between a locked position and a released position is arranged on the plug body 11. In the illustration in FIG. 1b, the lever is shown in the locked position. In the locked position, the lever 20 lies substantially parallel to a main direction of extent of the plug body 11 on the latter. In FIG. 1b, this main direction of extent is parallel to the axis x-x. In the released position, the lever is at a defined angle, for example at an angle in the range of greater than or equal to 80 degrees and less than or equal to 90 degrees, from the plug body 11. In the embodiment shown in FIG. 1a, the lever 20 is shown in an intermediate position between the released position and the locked position.

In the embodiment shown, the lever 20 has a first lever arm 21 and a second lever arm 22, which are aligned parallel to each other and are substantially mirror-symmetrical to each other. At a first end 23 of the first lever arm 21, the latter is connected to the plug body 11 so as to be rotatable about the virtual axis of rotation y-y. For this purpose, a stub shaft 160 is arranged on the plug body 11 and is received by a through-hole arranged in the lever arm 21. The second lever arm 22 is connected analogously and in a manner not shown in the figures at a first end rotatably about the virtual axis of rotation y-y with the plug body 11.

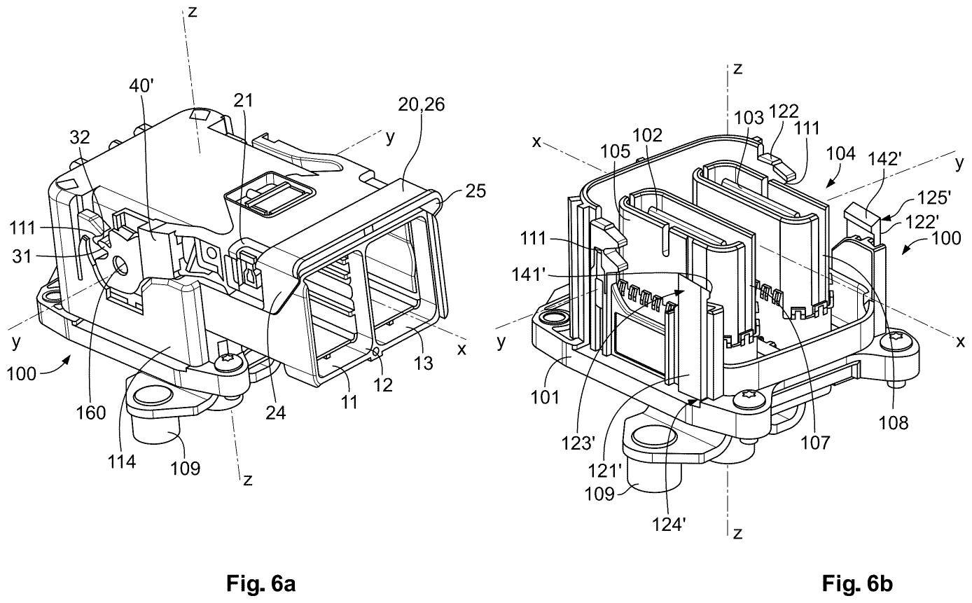

The first lever arm 21 and the second lever arm 22 are connected at their respective second ends 24, 25 to a bracket 26 oriented substantially perpendicular to the lever arms 21, 22. In the embodiment shown, the bracket 26 serves as an actuation point for a user. As can be seen in FIGS. 1 and 6, the first lever arm 21 and the second lever arm 22 are arranged on two opposite outer sides of the plug body 11, and, in the locked position, the lever arms 21, 22 and the bracket 26 lie flat against the plug body 11. In this way, accidental release of the lever 20 is prevented, at least to a large extent.

As can be seen in FIGS. 1a and 1b, for example, a first connecting structure is arranged at the respective first end of each lever arm 21, 22. In the embodiments shown in the figures, this first connecting structure is configured as a tooth 31 in each case, which is why the first connecting structure is referred to as tooth 31 in the following. However, it should be noted that in alternative embodiments not shown, the first connecting structure may also be configured differently, for example as a sequence of teeth, as a hook, as an undercut, or as a pin, etc. Since the teeth 31 arranged on the first lever arm 21 and on the second lever arm 22 are identical in design, the tooth 31 is also described in the singular below, wherein the features described are present both on the tooth 31 arranged on the first lever arm 21 and on the tooth 31 arranged on the second lever arm 22, which is not shown in the figures.

The tooth 31 of each lever arm 21 22 is configured to establish a mechanical connection with a corresponding second connecting structure arranged on the pin interface 100 in order to hold the plug connector 10 on the pin interface 100 when the plug connector 10 and the pin interface 100 are engaged with each other and the lever 20 is in the locked position. In the embodiments shown in the figures, the second connecting structure is a notch 111 arranged on two opposite outer sides 114, 115 of the pin interface 100. For this reason, the second connecting structure is also referred to as notch 111 in the following. In alternative embodiments not shown, the second connecting structure may also be configured as a group of teeth or notches, or as undercuts, etc.

In the locked position of the lever 20, the teeth 31 engage with the notches 111 and prevent relative displacement of the plug connector 10 with respect to the pin interface 100 along the mating direction z-z, as can be seen in FIGS. 1b and 6a.

In the released position of the lever 20, on the other hand, the teeth 31 are turned out of the corresponding notches 111 in such a way that displacement of the plug connector 10 relative to the pin interface 100 along the mating direction z-z is possible, so that the plug connector 10 can be released from or engaged with the pin interface 100 as required.

The mechanism operable by the lever 20 functions substantially as follows during the transition between the released and locked positions:

Each tooth 31 has a longitudinal axis which, as can be seen in FIG. 1, for example, is aligned in a radial direction with respect to the axis of rotation y-y, and has a free end 32 remote from the axis of rotation y-y, which, when the lever 20 is moved from the released position to the locked position, undergoes a movement that has a movement component along the mating direction z-z. In particular, when the lever 20 is moved from the released position to the locked position, the free end 32 moves in the opposite direction to that in which the plug body 11 is moved during the establishment of the connection. This can be understood, for example, by comparing the position of the tooth 31 in FIG. 1a with that in FIG. 1b. In the configuration shown in FIG. 1b, the free end 32 of the tooth 31 is closer to the side from which the plug connector 10 is placed on the pin interface 100 in relation to the mating direction z-z, or, in other words, “above” the position shown in FIG. 1a in relation to the axis of rotation y-y.

In this way, when engaged with the notch 111, the free end 32 pulls the plug body 11 along the mating direction z-z towards the pin interface 100 when the lever 20 is moved from the released position to the locked position.

The lever 20 has a first locking element 27 at the respective second ends 24, 25 of the first arm 21 and the second arm 22, respectively, which interacts with a corresponding second locking element 28 arranged on the plug body 11 to hold the lever 20 in the locked position on the plug body 11.

The connection of the teeth 31 to the notches 111 is arranged at a first distance close to the axis of rotation y-y and, when the plug connector 10 is engaged with the pin interface 100, substantially centrally above the contact assembly 104. In this way, this connecting structure reliably secures the plug connector 10 mechanically against centrally acting forces that would otherwise cause the plug connector 10 to lift evenly along the mating direction z-z.

In alternative embodiments not shown, the lever 20 comprises only a single lever arm arranged on one side of the plug body 11. However, the configuration shown with two lever arms 21, 22 has the advantage that the plug body 11 is held symmetrically on both sides of the pin interface 100 rather than on one side only.

As already indicated above, in order to be able to absorb an off-center lifting force and to prevent relative tilting between the pin interface 100 and the plug connector 10, which promotes wear, at least one elastic retaining component is arranged on the pin interface 100 and interacts mechanically with a corresponding retaining structure arranged on the plug body 11 in order to hold the plug connector 10 at the pin interface 100. The retaining component and the retaining structure are arranged perpendicular to the mating direction z-z and along the main direction of extent x-x of the plug body 11, away from the teeth 31 and the notches 111, so that a lever arm is formed between the two points of force transmission. This lever arm, which in FIG. 1b is the sum of the two distances D1 and D2 and is substantially identical to the distance D3 indicated on the side of the pin interface 100, enables tilting moments to be absorbed and thus prevents the plug connector 10 from tilting relative to the pin interface 100.

In the embodiments shown in the figures, two retaining components are arranged opposite each other in extension of the opposite outer sides 114, 115 of the pin interface 100 and are each configured as a first elastic spring arm 121 and a second elastic spring arm 122, respectively. The following therefore also refers to spring arms 121, 122 when referring to the retaining component or components. The first 121 and second 122 elastic spring arms each have a free end 123, 125 that can be deflected perpendicular to the mating direction z-z and a second end 124, 126 that is clamped to the pin interface 100 in a spring-elastic manner. Each spring arm 121, 122 extends substantially from the main body 101 in the mating direction z-z.

In the embodiments shown in FIGS. 1, 3, 4, and 5, the free ends 123, 124 have a first hook deformation 141 and a second hook deformation 142, respectively, which are inclined towards the respective opposite spring arm 12, 122.

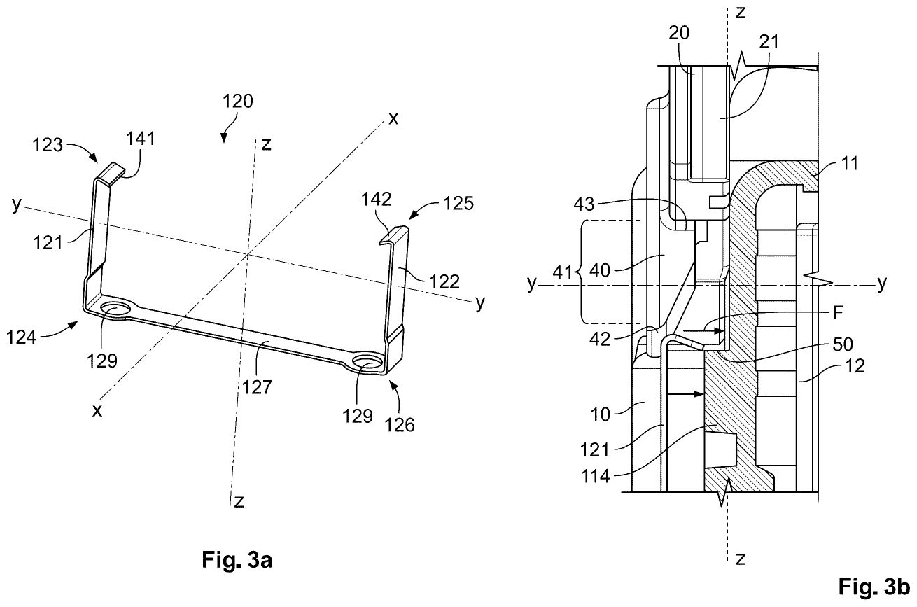

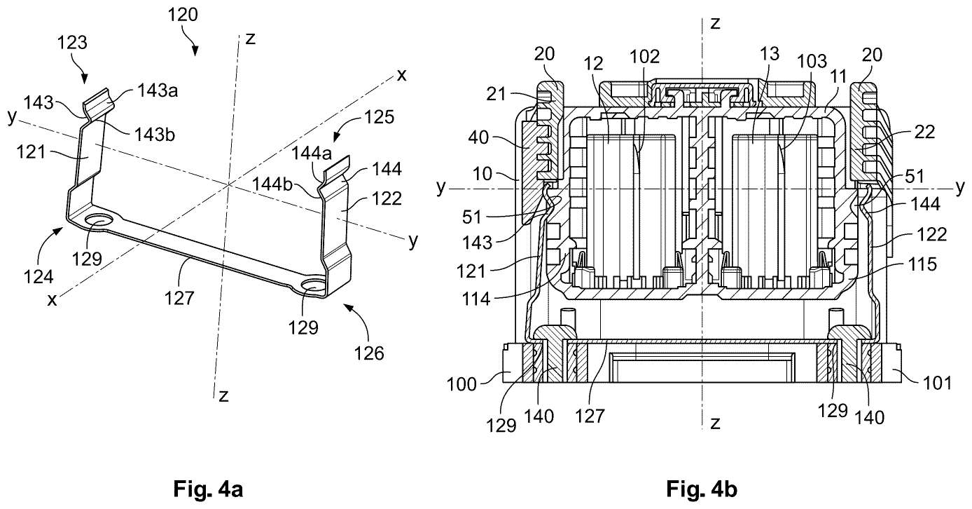

The two spring arms 121, 122 are connected to each other at their second ends 124, 126 by a connecting web 127, so that the first spring arm 121, the second spring arm 122, and the connecting web 127 form a substantially U-shaped spring bracket 120. The spring bracket 120 is connected to the main body 101 in the region of the connecting web 127, for example using pin-shaped connecting means such as screws or rivets. In the embodiments of FIGS. 3a and 4a, holes 129 are provided in the connecting web 127 for the purpose of fastening and are connected to the main body 101 by screws 140.

A person skilled in the art will recognize that the spring clips 120 shown in FIGS. 3a, 4a, and 5a can be stamped from a single piece of sheet metal and formed by bending in certain embodiments.

In the embodiment shown in FIGS. 1 and 3b, the retaining structures arranged on the plug body 11 are configured as shoulders 50 in the plug body 11, which are arranged so that, with respect to the mating direction z-z, they are at the same height as the corresponding free ends 123, 125 when the plug connector 10 and the pin interface 100 are engaged with each other.

The deflectable free ends 123, 125 are arranged such that they are deflected towards the plug body 11 by corresponding actuator components 40 arranged on the lever 20 at a second distance from the axis of rotation y-y when the lever 20 is in the locked position. In this way, the hook deformations 141, 142 engage in the shoulders 50, as indicated by the arrow F in FIG. 3b, and thus prevent the plug connector 10 from being lifted off the pin interface 100 in the region of the fastenings of the spring arms 121, 122 on the pin interface 100 in the direction of mating z-z. Since the spring arms 121, 122 are spaced apart from the fastening axis formed by the teeth 31 and the notches 111 in relation to the main direction of extent x-x of the plug body 10, lifting of the plug body 11 as a result of tilting can thus be minimized at least. When the lever 20 is in the released position and the actuator components 40 do not deflect the free ends 123, 125 of the spring arms 121, 122, the plug body 11 is free in the region of the shoulders 50 and can be moved along the mating direction z-z. This configuration is shown in FIG. 3b.

The embodiment of the spring bracket 120 shown in FIG. 4a differs from the embodiment shown in FIG. 3a in that no hook deformations are formed at the free ends 123, 125, but rather a first 143 and a second 144 bulge, each oriented substantially perpendicular to the main direction of extent of the respective spring arm 121, 122 and substantially V-shaped. The first bulge 143 and the second bulge 144 are oriented in such a way that flanks 143a, 143b, and 144a, 144b, respectively, through which the V-shaped bulges 143, 144 are formed, run in opposite directions to the mating direction z-z, as can be seen in FIG. 4a. The retaining structures on the plug body 11 are configured as corresponding V-shaped recesses 51, as shown in FIG. 4b, which precisely receive the V-shaped bulges 143, 144 when the free ends 123, 125 of the actuator components 40 are deflected in the direction of the plug body 11. With regard to the representation in FIG. 4b, it should be noted that the second lever arm 22 is shown in the figure without actuator component 40, and the spring clip 120 is therefore not deflected along the y-axis on the right-hand side of the drawing in relation to the z-axis. This representation was chosen in order to illustrate, based on the combined view of the right and left sides of the pin interface 100 in FIG. 4b, how the actuator components 40 and the spring clip 120 interact. While such a one-sided arrangement of an actuator component is conceivable, embodiments in which an actuator component 40 is arranged on each of the two lever arms 21, 22 are preferable in terms of their mechanical mode of operation, and accordingly, in the locked position of the lever 20, both bulges 143, 144 of the spring clip 120 are deflected into the corresponding recesses 51.

The interaction between the V-shaped bulges 143, 144 and the V-shaped recesses 51 substantially functions in the same way as the hook deformations 141, 142 described above. One advantage of the V-shaped bulges 143, 144 can be seen in the fact that the opposite flanks 143a, 143b and 144a, 144b of the V-shaped bulges 143, 144 prevent a relative displacement of the V-shaped bulges 143, 144 relative to the corresponding V-shaped recesses 51 in both directions along the mating direction z-z, while the hook deformations 141, 142 merely prevent the plug body 11 from lifting along the mating direction z-z. In general, it can therefore be assumed that the embodiment shown in FIG. 4 absorbs vibrations even better than the embodiment shown in FIG. 3.

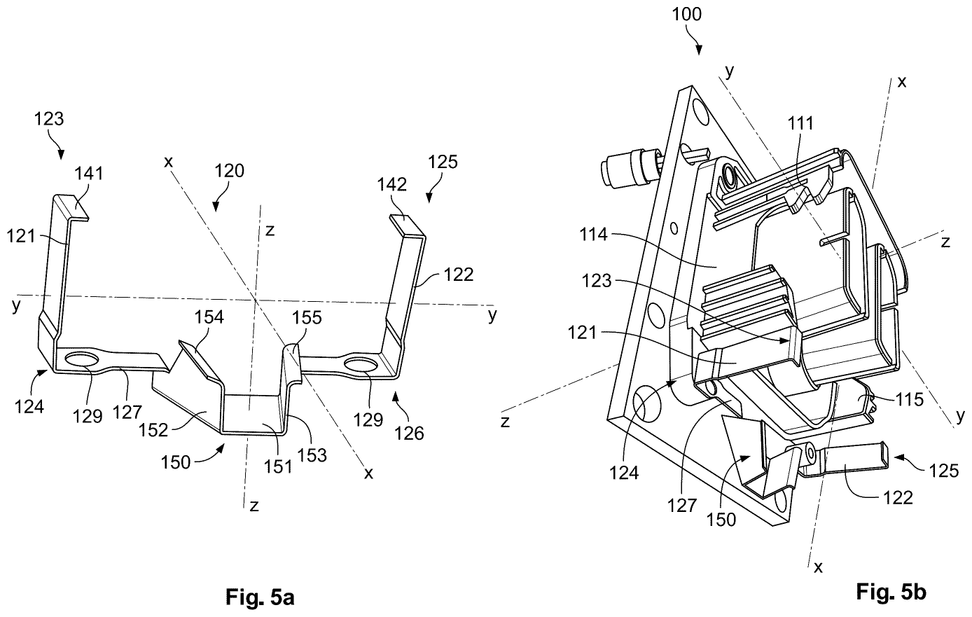

FIGS. 5a and 5b show an embodiment in which the spring clip 120 forms a support 150 in the centre of the connecting web 127, which extends substantially perpendicular to the mating direction z-z and defines an end position of the plug connector 10 when the plug connector 10 and the pin interface 100 are engaged with each other. As shown in FIG. 5a, the support 150 substantially forms a trough with a trough base 151 oriented perpendicular to the mating direction z-z and walls 152, 153 extending from it in the mating direction z-z. Chamfers 154, 155 on edges of the walls 152, 153 remote from the trough base 151 form contact surfaces with the plug body 11.

As can be seen in FIG. 5b, the support 150 projects from the connecting web 127 in the main direction of extent x-x of the plug body 11, so that it reacts elastically under pressure perpendicular to the projection. This means that by slightly tilting the support 150 in the direction of mating z-z, the support 150 is preloaded against the plug connector 10 when the plug connector 10 and the pin interface are engaged with each other. This allows any play in the electrical connection 1 that would otherwise occur due to vibrations to be overridden.

The design of the free ends 123, 125 is not fundamentally influenced by the design of the support 150, and both hook deformations 141, 142 and V-shaped bulges 143, 144 can be used in combination with the support 150.

In the embodiment shown in FIG. 6, unlike the embodiments shown in FIGS. 3 to 5, the retaining components are not formed in a separate spring clip 120, but are formed as spring arms 121′ in the main body 101. The main body 101 can be made, at least in some regions, of a suitable impact-and shock-resistant, yet elastic and electrically non-conductive plastic. The spring arms 121′ are clamped in the second ends 124′, 126′ by the one-piece design of the spring arms 121′, 122′ in the material of the main body 101. In the embodiment shown in FIG. 6b, the free ends 123′, 125′ are configured with hook deformations 141′, 142′ which interact with corresponding shoulders of the plug body 11 (not shown) in a similar manner to the hook deformations 141, 142 of the embodiment shown in FIG. 3b with the shoulders 50. In embodiments, the free ends 123′, 125′ of the spring arms 121′, 122′ formed in the main body 101 are formed with V-shaped bulges, similar to the embodiment shown in FIG. 4a.

The configuration of the actuator components 40 arranged on the lever 20 is described in more detail below. As already explained and as can be seen, for example, in FIG. 1b, the actuator components 40 are arranged at a second distance D2 from the axis of rotation y-y, which differs from a first distance D1 at which the first and second connecting structures, in the embodiments described, i.e. the teeth 31 and the notches 111, are arranged from the axis of rotation y-y. This creates a lever arm as the sum of the distances D1 and D2 between the respective mechanical fastenings, as already mentioned above.

Each actuator component 40 is also arranged on the lever arm 20 in such a way that, when the lever is moved from the released position to the locked position, it describes a path movement that has a movement component along the mating direction z-z of the plug connector 10 and the pin interface 100. As can be seen from FIG. 1b, this movement component runs in the opposite direction to the movement component performed by the free ends 32 of the teeth 31. This is because, in the embodiment shown, the first connecting structure is arranged on a first side of the virtual axis of rotation y-y in the locked position of the lever 20 with respect to a main direction of extent of the lever, which coincides with the x-x axis in the figures, and the actuator component 40 is arranged on a second side opposite the first side.

The actuator components 40 further have, as shown in FIG. 3b, a substantially wedge-shaped pressure region 41 with a pointed end 42 and a broad end 43, wherein the pointed end 42 is oriented such that, when the lever 20 is moved from the released position to the locked position, the pointed end points substantially in the direction of movement.

The pressure region 41 has a surface 44 inclined in relation to the direction of movement, which connects the pointed end 42 to the broad end 43 and is configured to contact the respective free end of the spring arms 121, 121′, 122, 122′ and deflect them perpendicular to the direction of movement of the lever 20 in the direction of the plug body 11.

The actuator components 40 can either be formed integrally with the lever 20 or can be attached to the lever 20 as separate components.

The invention is not limited to the exemplary embodiments described and illustrated. Rather, it also encompasses all technical developments within the scope of the invention defined by the claims. In addition to the embodiments described and illustrated, further embodiments are conceivable which may comprise further modifications and combinations of features.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical plug connector for establishing an electrical and mechanical connection with a corresponding pin interface, the electrical plug connector comprising:
a plug body configured to receive at least one electrical conductor;
a lever mounted on the plug body so as to be rotatable about a virtual axis of rotation between a locked position and a released position;
at least one first connecting structure arranged on the lever at a first distance from the axis of rotation, the at least one first connecting structure is configured, in the locked position of the lever, to interact with at least one corresponding second connecting structure arranged on the pin interface to hold the plug connector on the pin interface when the plug connector and the pin interface are engaged with each other, the at least one first connecting structure is configured, in the released position of the lever, to allow displacement of the plug connector relative to the pin interface; and
at least one actuator component arranged on the lever at a second distance from the axis of rotation, the at least one actuator component is configured, in the locked position of the lever, to deflect at least one elastic retaining component arranged at the pin interface in such a way that it interacts with a corresponding retaining structure arranged on the plug body to hold the plug connector at the pin interface when the plug connector and the pin interface are engaged with each other, the at least one actuator component is configured, in the released position of the lever, to allow displacement of the plug connector relative to the pin interface.

2. The electrical plug connector according to claim 1, wherein the lever comprises at least a first lever arm with a first end and a second end, and the first lever arm is connected to the plug body at the first end so as to be rotatable about the virtual axis of rotation, wherein the actuator component is arranged on the first lever arm in such a way that, when the lever is moved from the released position to the locked position, the actuator component defines a path movement that has a movement component along a mating direction of the plug connector and the pin interface.

3. The electrical plug connector according to claim 2, wherein the actuator component has a substantially wedge-shaped pressure region with a pointed end and a broad end, wherein the pointed end is oriented such that, when the lever is moved from the released position to the locked position, the pointed end points substantially in the direction of movement.

4. The electrical plug connector according to claim 3, wherein the pressure region has a surface inclined relative to the direction of movement, which connects the pointed end to the broad end, and which is arranged to contact a free end of the retaining component and to deflect it perpendicular to the direction of movement of the lever in the direction of the plug body, during a movement of the lever from the released position into the locked position.

5. The electrical plug connector according to claim 2, wherein the first lever arm has a first latching element at the second end, which is configured to interact with a corresponding second latching element arranged on the plug body in order to hold the lever in the locked position on the plug body.

6. The electrical plug connector according to claim 5, wherein the first connecting structure is arranged at the first end of the first lever arm and the actuator component is arranged between the first end of the first lever arm and the first latching element.

7. The electrical plug connector according to claim 2, wherein the lever comprises a second lever arm which is aligned parallel to the first lever arm and is formed substantially mirror-symmetrical to it, wherein the first lever arm and the second lever arm are connected at their respective second ends to a bracket oriented substantially perpendicular to the lever arms.

8. The electrical plug connector according to claim 1, wherein the first connecting structure is arranged in the locked position of the lever in relation to a main direction of extent of the lever on a first side of the virtual axis of rotation and the actuator component on a second side opposite the first side.

9. The electrical plug connector according to claim 1, wherein the first connecting structure comprises at least one tooth of which the longitudinal axis is aligned in a radial direction with respect to the axis of rotation.

10. The electrical plug connector according to claim 9, wherein the at least one tooth has a free end remote from the axis of rotation, which, when the lever is moved from the released position to the locked position, undergoes a movement that has a movement component along the mating direction of the plug connector and the pin interface.

11. An electrical pin interface for establishing an electrical connection with a corresponding plug connector having at least one first connecting structure, the electrical pin interface comprising:
a main body;
a contact assembly with at least one electrical contact held on the main body and at least partially surrounded by contact assembly;
the main body having at least one second connecting structure, the at least one second connecting structure is configured to cooperate with the at least one corresponding first connecting structure arranged on the plug connector in order to hold the plug connector on the pin interface when the plug connector and the pin interface are engaged with each other;
at least one elastic retaining component arranged on a lever of the plug connector at a distance from the second connecting structure, the at least one elastic retaining component is configured to be deflected by at least one actuator component arranged on the plug connector in such a way that the at least one elastic retaining component interacts with a corresponding retaining structure arranged on a plug body of the plug connector in order to hold the plug connector at the pin interface when the plug connector and the pin interface are engaged with each other.

12. The electrical pin interface according to claim 11, wherein the at least one retaining component comprises a spring arm, which extends along a mating direction of the pin interface and the plug connector and which has a free end that can be deflected perpendicular to the mating direction and a second end that is clamped to the pin interface in a spring-elastic manner.

13. The electrical pin interface according to claim 12, wherein:
the free end has a hook deformation and the retaining structure has a shoulder corresponding to the hook deformation; or
the free end has a substantially V-shaped bulge oriented substantially perpendicular to a main direction of extent of the spring arm and the retaining structure has a corresponding V-shaped recess.

14. The electrical pin interface according to claim 11, wherein the at least one retaining component is formed in the main body.

15. The electrical pin interface according to claim 14, wherein the spring clip forms a support, which extends substantially perpendicular to the mating direction in the region of the connecting web, and which defines an end position of the plug connector when the plug connector and the pin interface are engaged with each other.

16. The electrical pin interface according to claim 11, wherein the at least one retaining component comprises a first retaining component and a second retaining component which are connected to each other at respective second ends by a connecting web so that the first retaining component, the second retaining component, and the connecting web form a substantially U-shaped spring clip; wherein the spring clip is connected to the main body in the region of the connecting web.

17. The electrical pin interface according to claim 11, wherein the second connecting structure comprises at least one notch corresponds to the corresponding first connecting structure and which is aligned in its longitudinal direction substantially perpendicular to the mating direction.
